(19) United States
(12) Patent Application Publication
(10) Pub. No.: US 2025/0292081 A1
(43) Pub. Date: Sep. 18, 2025

(54) NEURAL NETWORK DEVICE, SYNAPTIC WEIGHT UPDATE METHOD, AND COMPUTER PROGRAM PRODUCT

(71) Applicant: KABUSHIKI KAISHA TOSHIBA, Tokyo (JP)

(72) Inventors: Yoshifumi NISHI, Yokohama Kanagawa (JP); Kumiko NOMURA, Shinagawa Tokyo (JP)

(73) Assignee: KABUSHIKI KAISHA TOSHIBA, Tokyo (JP)

(21) Appl. No.: 19/062,388

(22) Filed: Feb. 25, 2025

(30) Foreign Application Priority Data
Mar. 18, 2024 (JP) 2024-042203

(51) Int. Cl. G06N 3/08; G06N 3/049; G06N 3/063

(52) U.S. Cl. CPC G06N 3/08; G06N 3/049; G06N 3/063

(57) ABSTRACT

A neural network device according to an embodiment includes a plurality of neuron circuits and a plurality of synapse circuits. In a case where an internal state value of a second neuron circuit is larger than a set determination reference value, a first synapse circuit among the synapse circuits executes potentiation processing to increase the degree of influence of a synaptic weight on a synapse signal in response to acquiring the input spike from the first neuron circuit. In response to outputting an output spike being a spike signal from the second neuron circuit, the first synapse circuit executes attenuation processing to decrease the degree of influence of the synaptic weight on the synapse signal.

### CROSS-REFERENCE TO RELATED APPLICATIONS

This application is based upon and claims the benefit of priority from Japanese Patent Application No. 2024-042203, filed on Mar. 18, 2024; the entire contents of which are incorporated herein by reference.

### FIELD

Embodiments described herein relate generally to a neural network device, a synaptic weight update method, and a computer program product.

### BACKGROUND

In recent years, with advances in computer hardware, typified by graphical processing units (GPU), artificial intelligence technology has been rapidly developing. For example, image recognition and classification techniques, typified by convolutional neural networks (CNN), have already been used in various scenes in the real world. Artificial intelligence technology that is widely used now is based on the mathematical model in which the behavior of a biological neural circuit network is simplified. Such artificial intelligence technology is therefore implemented using computers, such as GPUs.

However, implementation of the artificial intelligence technology with GPUs requires a large amount of power. In particular, learning operation in which features are extracted from a large volume of data and stored comes with an enormous amount of computation. For this reason, such a learning operation requires a very large amount of power, and is considered to be difficult to execute in an edge device or the like.

On the other hand, although energy consumption of the human brain is as low as 20 W, the human brain constantly learns an enormous volume of data online. Therefore, a technique of performing information processing by relatively faithfully reproducing brain activity by electric circuits has been studied in various countries of the world.

In the brain's neural circuit network, information is transmitted from a neuron (nerve cell) to a neuron as a signal of a voltage spike. A coupler called a synapse couples a neuron to a neuron. When a certain neuron fires and a voltage spike occurs, the voltage spike is input to a post-neuron as a subsequent stage via a synapse. At this time, the strength of the voltage spike input to the post-neuron is adjusted by the coupling strength of the synapse (also called a synaptic weight). When the synaptic weight is large, the voltage spike is transmitted to the post-neuron with high strength. However, in a case where the synaptic weight is small, the voltage spike will have a low strength and be transmitted to the post-neuron. Accordingly, in the neural circuit network of the brain, the larger the synaptic weight connecting the two neurons, the greater the informational relationship between the two neurons.

The synaptic weight is known to change depending on the firing timing of the neuron. Assuming that a voltage spike is input from a certain neuron (pre-neuron) to the next neuron (post-neuron) via a synapse, firing of the post-neuron indicates a presence of a causal relationship between the information held by these two neurons, leading to an increase of the synaptic weight in the synapse between these two neurons. In contrast, when a voltage spike arrives from a pre-neuron to a post-neuron after the post-neuron fires, there is no causal relationship between information held by these two neurons, leading to a decrease of the synaptic weight in the synapse between these two neurons. The property of the synaptic weight that changes depending on the timing of the voltage spike in this manner is called Spike Timing Dependent Plasticity (STDP).

Such information processing mimicking the information transmission principle of the brain's neural circuit network is called spiking neural networks. The spiking neural network performs no numerical computation and performs information processing by accumulating, generating, and transmitting voltage spikes. Conventional artificial intelligence requires an enormous amount of computation in learning operation. However, the spiking neural network learns synaptic weights using an update rule, such as STDP, and can therefore perform efficient learning operation. For such reasons, in recent years, studies of implementing a spiking neural network on a semiconductor chip have been actively conducted.

As described above, STDP is a phenomenon in which the weight of the synapse changes depending on the timing of the voltage spike due to the firing of the pre-neuron and the post-neuron connected to the synapse. Therefore, in order to implement the spiking neural network on a semiconductor chip, there is a need to provide a mechanism of measuring a time difference at each synapse. An electric circuit for actualizing this mechanism can be technically implemented relatively easily using a device such as a capacitor, for example, which, however, might enlarge a circuit scale. In particular, when the total number of neurons is A (A is an integer of 2 or more), the number of synapses in the neural network is on the order of A×A, having a great impact on the dimensions of the spiking neural network chip.

### BRIEF DESCRIPTION OF THE DRAWINGS

FIG. 1 is a diagram illustrating a configuration of a neural network device according to an embodiment;

FIG. 2 is a configuration diagram of a reservoir computing apparatus according to the embodiment;

FIG. 3 is a diagram illustrating an internal partial configuration of the neural network device according to the embodiment;

FIG. 4 is a flowchart illustrating a procedure of synaptic weight potentiation processing;

FIG. 5 is a flowchart illustrating a procedure of a synaptic weight attenuation processing;

FIG. 6 is a circuit configuration diagram of a synapse unit and a neuron unit;

FIG. 7 is a circuit configuration diagram of a potentiation determination unit;

FIG. 8 is a circuit configuration diagram of a potentiation unit;

FIG. 9 is a circuit configuration diagram of an attenuation unit;

FIG. 10 is a configuration diagram of a weight storage circuit;

FIG. 11 is a configuration diagram of a weight storage circuit using a flash memory cell;

FIG. 12 is a diagram illustrating a circuit example of a weight storage circuit at the time of reading;

FIG. 13 is a diagram illustrating a circuit example of a weight storage circuit at the time of update;

FIG. 14 is a configuration diagram of each of two or more synapse units each including a flash memory cell;

FIG. 15 is a graph illustrating a recognition rate obtained by simulation;

FIG. 16 is a diagram illustrating a receptive field obtained by simulation; and

FIG. 17 is a diagram illustrating an example of a hardware configuration of a neural network device.

### DETAILED DESCRIPTION

A neural network device according to an embodiment includes a plurality of neuron circuits and a plurality of synapse circuits. Each of the neuron circuits is configured to receive a synapse signal output from each of one or more of the synapse circuits, increase an internal state value representing an internal state in response to receiving the synapse signal, output a spike signal in accordance with the internal state value, and decrease the internal state value in response to outputting the spike signal. Each of the synapse circuits is configured to store a synaptic weight, acquire an input spike being the spike signal output from a first neuron circuit being one of the neuron circuits, and output, to a second neuron circuit being one of the neuron circuits, the synapse signal obtained by adding influence of the synaptic weight to the acquired input spike. A first synapse circuit being one of the synapse circuits is configured to, when the internal state value of the second neuron circuit is larger than a determination reference value, execute potentiation processing to increase a degree of influence of the synaptic weight on the synapse signal in response to acquiring the input spike from the first neuron circuit, and execute attenuation processing to decrease the degree of influence of the synaptic weight on the synapse signal in response to outputting an output spike being the spike signal from the second neuron circuit.

For solving the problem of STDP, there is a proposed method of changing a synaptic weight without using a time difference. In this method, when a spike is input to a synapse, the synaptic weight is either potentiated, attenuated, or maintained by an inner potential (Vₘₑₘ) of the post-neuron. Specifically, the method sets Vᵤₚ and V_{down} as constants. Vᵤₚ is greater than V_{down}. In a case where a spike is input to the synapse, this method increases the synaptic weight when Vₘₑₘ>Vᵤₚ, decreases the synaptic weight when Vₘₑₘ<V_{down}, and maintains the synaptic weight when V_{down}≤Vₘₑₘ≤Vᵤₚ.

This method does not use a time difference, but is related to STDP. The condition Vₘₑₘ>Vᵤₚ, which is a potentiation condition, indicates that it is a timing at which firing will occur soon if Vᵤₚ is set in the vicinity of Vth which is lower than Vth being a firing threshold. Therefore, in a case where a spike is input to the synapse in the state of Vₘₑₘ>Vᵤₚ, it is estimated that there is a causal relationship between the input synapse and firing in the post-neuron. When V_{down} is set in the vicinity of Vreset which is higher than Vreset being the reset potential, Vₘₑₘ<V_{down} being an attenuation condition indicates the timing immediately after firing. Therefore, in a case where the spike is input to the synapse in the state of Vₘₑₘ<V_{down}, it is estimated that there is no causal relationship between the input synapse and the firing in the post-neuron. Such a method is called Spike Driven Synaptic Plasticity (SDSP), and can be implemented on a semiconductor chip with a configuration smaller than that of STDP.

Meanwhile, the SDSP works on a premise that a spike is input from the pre-neuron. Conversely, in a situation where the input of information is extremely small, there is no input of a spike from the pre-neuron, having no change in the synaptic weight, namely, the weight of the synapse. This causes the following problems.

For example, here is an assumable case of performing learning by inputting an image pattern of 10×10 pixels to a spiking neural network.

First, an image (image A) of a pattern spreading over an entire frame of 10×10 pixels is repeatedly input to the spiking neural network. In this case, in the spiking neural network, the synaptic weight of the synapse is updated by learning using the principle of the SDSP, leading to acquisition of a synaptic weight distribution according to this pattern.

The subsequent step is to repeatedly input an image (image B) in which a pattern exists only in part of the center in a frame of 10×10 pixels and a peripheral part is blank to the spiking neural network after such learning. It is assumed here that most pixels of the image B are blank.

In the spiking neural network, input information is expressed by density of spikes. Therefore, a blank is represented as a spike density of zero in the spiking neural network. Therefore, no spike is input to most synapses in the spiking neural network, having no change in the synaptic weight. In other words, even after repeated attempt of learning of the image B, the spiking neural network cannot newly learn the image B with a residual synaptic weight distribution corresponding to the image A. In this manner, in a case where new information having low spike density is input, the SDSP cannot learn this new information with residual information of the past learning, causing a problem of deterioration of inference accuracy.

Hereinafter, a neural network device 10 according to an embodiment for solving the above problem will be described with reference to the drawings.

The neural network device 10 according to the embodiment is a spiking neural network configured by hardware, and updates a synaptic weight by a predetermined update rule. The neural network device 10 according to the embodiment can achieve learning with high accuracy with a small configuration. As a result, the neural network device 10 according to the embodiment can execute accurate inference with a small configuration.

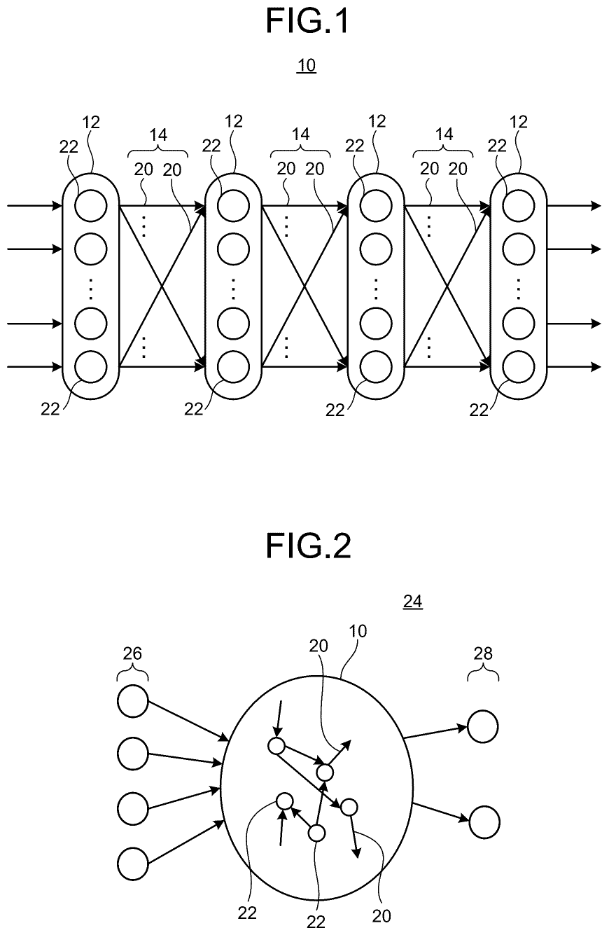

FIG. 1 is a diagram illustrating an example of a configuration of the neural network device 10 according to the embodiment. As an example, the neural network device 10 according to the embodiment includes M (M is an integer of 2 or more) layers 12 and (M−1) synapse groups 14.

Each of the (M−1) synapse groups 14 includes a plurality of synapse units 20 (an example of a plurality of synapse circuits). Each of the synapse units 20 stores a synaptic weight. Each of the M layers 12 includes a plurality of neuron units 22 (an example of a plurality of neuron circuits).

An m-th (m is an integer of 1 or more and (M−1) or less) synapse group 14 among the (M−1) synapse groups 14 is disposed between an m-th layer 12 of the M layers 12 and an (m+1)-th layer 12 of the M layers 12.

Each of the synapse units 20 included in the m-th synapse group 14 acquires a spike signal output from any one neuron unit 22 of the plurality of neuron units 22 included in the m-th layer 12. Each of the synapse units 20 included in the m-th synapse group 14 generates a synapse signal obtained by adding the influence of the synaptic weight that has been set, to the spike signal received. Each of the synapse units 20 included in the m-th synapse group 14 applies a synapse signal to one neuron unit 22 among the neuron units 22 included in the (m+1)-th layer 12.

Each of the neuron units 22 included in the (m+1)-th layer 12 among the M layers 12 acquires a plurality of synapse signal output from the m-th synapse group 14, and executes processing corresponding to product-sum operation on the plurality of synapse signals acquired. Note that the first layer 12 of the M layers 12 acquires a plurality of signals from an external device or an input layer. Subsequently, each of the neuron units 22 outputs a spike signal obtained by performing processing corresponding to an activation function on the signal representing the operation result. Note that the output of the spike signal by the neuron unit 22 is also referred to as firing.

In such a neural network device 10, the first layer 12 receives one or more signals from an external device or an input layer. Subsequently, the neural network device 10 outputs, from the m-th layer 12, one or more signals indicating a result of the operation executed by the neural network on the one or more signals received.

FIG. 2 is a diagram illustrating a configuration of a reservoir computing apparatus 24 according to the embodiment.

The neural network device 10 is not limited to the structure of transferring a signal in the forward direction as illustrated in FIG. 1, and may be a recurrent neural network of performing internal feedback of signals. In a case where the neural network device 10 is a recurrent neural network, for example, the neural network device 10 is applicable to the reservoir computing apparatus 24 as illustrated in FIG. 2.

The reservoir computing apparatus 24 includes: an input layer 26, a neural network device 10 being a recurrent neural network; and an output layer 28.

The input layer 26 acquires one or more signals from an external device. The input layer 26 outputs the acquired one or more signals to the neural network device 10. The output layer 28 acquires one or more spike signals from the neural network device 10. Subsequently, the output layer 28 outputs one or more signals to an external device.

Each of the neuron units 22 included in the neural network device 10 acquires a plurality of synapse signals from some synapse unit 20 among the synapse units 20 included in the neural network device 10. In addition, some of the neuron units 22 among the neuron units 22 acquire signals from the input layer 26. In addition, some of the neuron units 22 among the neuron units 22 output a spike signal to the output layer 28.

Each of the synapse units 20 acquires the spike signal output from any one neuron unit 22 among the neuron units 22. Each of the synapse units 20 outputs a synapse signal to any one neuron unit 22 among the neuron units 22.

Subsequently, at least one of the synapse units 20 performs feedback of a synapse signal and outputs the synapse signal to the own circuit or another neuron unit 22. At least one of the synapse units 20 outputs the synapse signal to the own circuit, the neuron unit 22 that has given a spike signal to the synapse unit 20, or the neuron unit 22 at a preceding stage of the neuron unit 22 that has given the spike signal to the own circuit.

The reservoir computing apparatus 24 having such a configuration can function as a hardware device that performs reservoir computing.

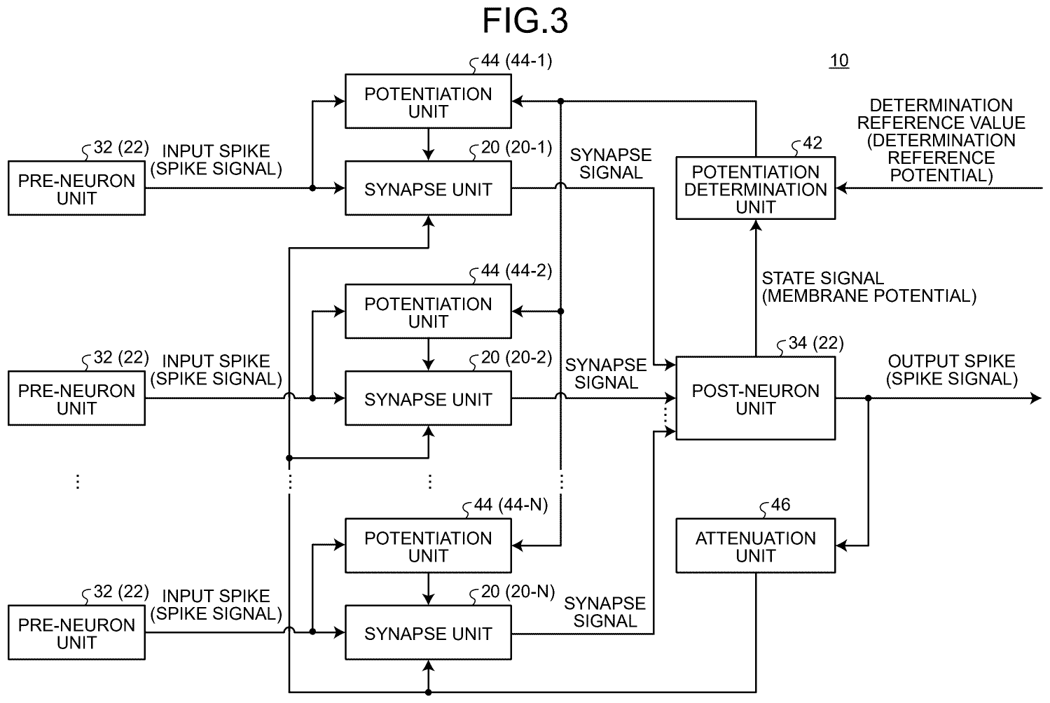

FIG. 3 is a diagram illustrating a connection relationship between functional blocks around the synapse units 20 according to the embodiment.

Each of the synapse units 20 acquires an input spike, which is a spike signal output from a pre-neuron unit 32 (first neuron unit) being any one of the neuron units 22. Each of the synapse units 20 then outputs a synapse signal obtained by adding the influence of the stored synaptic weight to the acquired input spike to a post-neuron unit 34 (second neuron unit) which is any one of the neuron units 22. The pre-neuron unit 32 and the post-neuron unit 34 may be identical to each other. In other words, the first neuron unit and the second neuron unit may be identical to each other.

For example, each of the synapse units 20 outputs a synapse signal representing a value obtained by multiplying the input spike by the synaptic weight, to the post-neuron unit 34. For example, in a case where the spike signal is a pulse signal, each of the synapse units 20 outputs, in response to acquiring the acquisition of the input spike, a synapse signal of a current amount corresponding to the synaptic weight. Alternatively, each of the synapse units 20 may output a synapse signal having an amplitude voltage according to the synaptic weight or a pulsed synapse signal having a pulse width according to the synaptic weight. This makes it possible for each of the synapse units 20 to output a synapse signal including the influence of the synaptic weight added to the input spike.

Each of the neuron units 22 holds an internal state value representing an internal state. Each of the neuron units 22 receives a synapse signal output from each of one or more synapse units 20 among the synapse units 20, and increases the internal state value in response to receiving the synapse signal. Each of the neuron units 22 outputs a spike signal in accordance with the internal state value.

In the present embodiment, each of the neuron units 22 outputs a spike signal when the internal state value becomes larger than a preset firing threshold. Subsequently, each of the neuron units 22 decreases the internal state value in response to outputting the spike signal. In the present embodiment, each of the neuron units 22 changes the internal state value to a preset initial value in response to outputting the spike signal. Note that the initial value is a value smaller than the firing threshold.

When each of the neuron units 22 is an analog circuit, the internal state value is, for example, a membrane potential being a voltage. In this case, each of the neuron units 22 includes a device such as a capacitor that holds a membrane potential. In addition, when each of the neuron units 22 is an analog circuit, the firing threshold is a preset threshold potential.

In the present embodiment, the spike signal is a voltage pulse. In this case, the spike signal changes, for example, from a first voltage value (for example, 0 V) to a second voltage value at the firing timing at which the membrane potential becomes larger than the threshold potential, and changes from the second voltage value to the first voltage value at the reset timing at a point after a certain time has elapsed from the firing timing. In addition, each of the neuron units 22 outputs a spike signal, and then resets the membrane potential to an initial potential representing an initial value.

Here, the synaptic weight stored in each of the synapse units 20 is updated by a predetermined update rule. The neural network device 10 includes: a potentiation determination unit 42 (an example of a potentiation determination circuit); N potentiation units 44 (44-1 to 44-N); and an attenuation unit 46, as functions of updating the synaptic weights stored in N synapse units 20 (20-1 to 20-N) (N is an integer of 2 or more) sharing the post-neuron unit 34, among the synapse units 20.

The potentiation determination unit 42 acquires a state signal indicating an internal state value of the post-neuron unit 34. In the present embodiment, the potentiation determination unit 42 acquires the membrane potential held by the post-neuron unit 34. The potentiation determination unit 42 has a preset determination reference value. In the present embodiment, in the potentiation determination unit 42 has a preset determination reference potential representing a determination reference value.

When the internal state value of the post-neuron unit 34 is larger than the determination reference value, the potentiation determination unit 42 outputs a potentiation condition satisfaction signal indicating that the potentiation condition is satisfied. In addition, when the internal state value of the post-neuron unit 34 is the determination reference value or less, the potentiation determination unit 42 does not output the potentiation condition satisfaction signal. For example, when the membrane potential of the post-neuron unit 34 is larger than the determination reference potential, the potentiation determination unit 42 outputs a potentiation condition satisfaction signal indicating that the potentiation condition is satisfied. In addition, when the membrane potential of the post-neuron unit 34 is the determination reference potential or less, the potentiation determination unit 42 does not output the potentiation condition satisfaction signal.

Here, the determination reference value is set to a value being smaller than the firing threshold set in the post-neuron unit 34 and being in the vicinity of the firing threshold. For example, the determination reference potential is set to a value being smaller than the firing potential set in the post-neuron unit 34 and being in the vicinity of the firing potential. Therefore, in a case where the post-neuron unit 34 will fire soon, for example, in a case where the post-neuron unit 34 will fire when a synapse signal is given to the post-neuron unit 34 next time, the potentiation determination unit 42 can output a potentiation condition satisfaction signal indicating satisfaction of the potentiation condition.

The N potentiation units 44 correspond one-to-one to the N synapse units 20 that output synapse signals to the post-neuron unit 34. Each of the N potentiation units 44 acquires an input spike input to a corresponding synapse unit 20 among the N synapse units 20. In a case where the potentiation condition satisfaction signal has been output from the potentiation determination unit 42 at a timing of acquisition of the corresponding input spike, each of the N potentiation units 44 gives a potentiation signal for potentiating the synaptic weight to the corresponding synapse unit 20.

The attenuation unit 46 acquires an output spike, which is a spike signal, from the post-neuron unit 34. When an output spike has been output from the post-neuron unit 34, the attenuation unit 46 gives an attenuation signal to all of the N synapse units 20 that output a synapse signal to the post-neuron unit 34.

When having acquired the potentiation signal from the corresponding potentiation unit 44, each of the N synapse units 20 executes potentiation processing to increase a degree of influence of the synaptic weight on the synapse signal. In addition, when having acquired the attenuation signal from the attenuation unit 46, each of the N synapse units 20 executes attenuation processing to reduce the degree of influence of the synaptic weight on the synapse signal.

For example, each of the N synapse units 20 increases the synaptic weight by a predetermined first change amount in the potentiation processing. Moreover, in a case where the synaptic weight is represented by a discrete value, for example, each of the N synapse units 20 may increase the synaptic weight by a predetermined first change amount at a predetermined first probability in the potentiation processing. In a case where an upper limit value is set to the synaptic weight, each of the N synapse units 20 does not set the synaptic weight to be larger than the upper limit value in the potentiation processing.

For example, each of the N synapse units 20 decreases the synaptic weight by a predetermined second change amount in the attenuation processing. Moreover, in a case where the synaptic weight is represented by a discrete value, for example, each of the N synapse units 20 may decrease the synaptic weight by a predetermined second change amount at a predetermined second probability in the attenuation processing. In a case where a lower limit value is set to the synaptic weight, each of the N synapse units 20 does not set the synaptic weight to be smaller than the lower limit value in the attenuation processing.

From the above, any one of the first synapse units 20-1 among the synapse units 20 included in the neural network device 10 executes the following synaptic weight update processing. That is, in a case where the internal state value of the post-neuron unit 34 is larger than the determination reference value, the first synapse unit 20-1 executes potentiation processing to increase the degree of influence by the synaptic weight in response to acquiring the acquisition of the input spike from the pre-neuron unit 32. Additionally, in response to outputting the output spike from the post-neuron unit 34, the first synapse unit 20-1 executes attenuation processing to decrease the degree of influence of the synaptic weight.

When the post-neuron unit 34 outputs a pulse signal as an output spike, the potentiation determination unit 42 may change the determination reference potential in accordance with the occurrence frequency of the spike signal per unit time. For example, the potentiation determination unit 42 may perform setting such that the higher the occurrence frequency, the larger the determination reference value will be. This makes it possible for the potentiation determination unit 42 to prevent a situation in which the increased occurrence frequency of the output spike would excessively reinforce the synaptic weight.

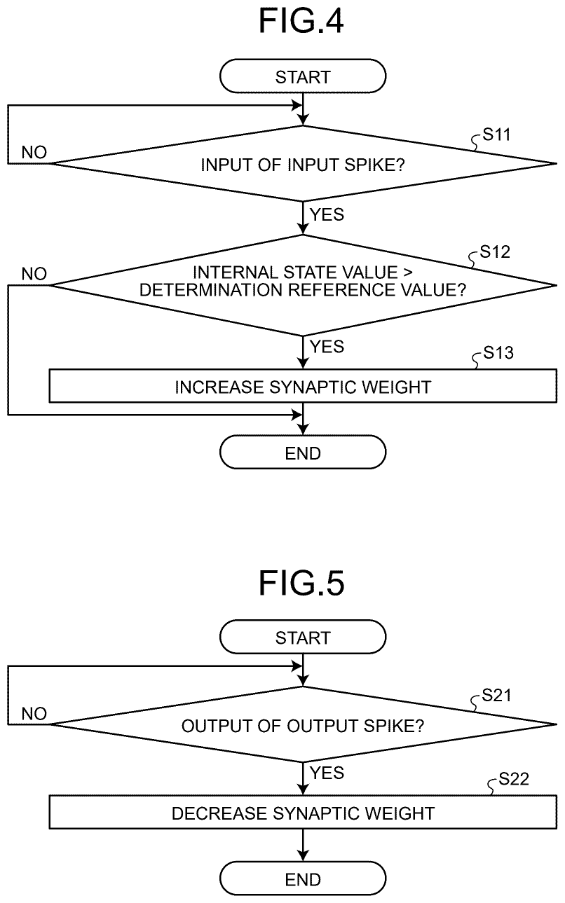

FIG. 4 is a flowchart illustrating a procedure of potentiation processing on the synaptic weight stored in the optionally selected first synapse unit 20-1 in the neural network device 10.

In S11, the neural network device 10 determines whether an input spike has been input to the first synapse unit 20-1. When the input spike has not been input (No in S11), the neural network device 10 waits for the processing in S11. When the input spike has been input (Yes in S11), the neural network device 10 proceeds to the processing of S12.

In S12, the neural network device 10 determines whether the internal state value of the post-neuron unit 34 is larger than the determination reference value. When the internal state value is not larger than the determination reference value (No in S12), the neural network device 10 maintains the synaptic weight and ends the present flow. When the internal state value is larger than the determination reference value (Yes in S12), the neural network device 10 proceeds to the processing of S13.

In S13, the neural network device 10 increases the synaptic weight stored in the first synapse unit 20-1 by a first change amount (Δwᵤₚ). After completion of the processing of S13, the neural network device 10 ends the present flow.

FIG. 5 is a flowchart illustrating a procedure of attenuation processing on the synaptic weight stored in the optionally selected first synapse unit 20-1 in the neural network device 10.

First, the neural network device 10 determines, in S21, whether an output spike has been output from the post-neuron unit 34. When the output spike has not been output (No in S21), the neural network device 10 waits for the processing in S21. When the output spike has been output (Yes in S21), the neural network device 10 proceeds to the processing of S22.

In S22, the neural network device 10 decreases the synaptic weight stored in the first synapse unit 20-1 by a second change amount (Δw_{down}). After completion of the processing of S22, the neural network device 10 ends the present flow.

From the above, in a case where an input spike has been input, the first synapse unit 20-1 executes the potentiation processing in Formula (1) on the condition that Vₘₑₘ>Vᵤₚ.

$${w}_{1} = {w}_{1} + Δ {w}_{u p} \qquad ( 1 )$$

w₁ represents a synaptic weight stored in the first synapse unit 20-1. Δwᵤₚ represents the first change amount. Vₘₑₘ represents an internal state value (membrane potential). Vᵤₚ represents a determination reference value (determination reference potential).

In addition, in a case where the output spike has been output from the post-neuron unit 34, the first synapse unit 20-1 unconditionally executes the attenuation processing in Formula (2).

$${w}_{1} = {w}_{1} - Δ {w}_{down} \qquad ( 2 )$$

Δw_{down} represents the second change amount.

When the synaptic weight is a real number, the first change amount (w₁) and the second change amount (w₂) are positive real numbers. In this case, the first change value (w₁) may be a value larger than the second change value (w₂). For example, the ratio setting may be performed such that the larger the number of the synapse units 20 that output the synapse signal to the post-neuron unit 34, the larger the ratio of the first change amount (w₁) to the second change amount (w₂). For example, there is a case where the total value of the synaptic weights of the synapse units 20 that output the synapse signal to the post-neuron unit 34 is to be desirably constant regardless of the progress of learning. In the synaptic weight update rule of the present embodiment, in a case where the output synapse is output once, the attenuation processing is performed on the synapse units 20. However, in a case where the internal state value exceeds the determination reference value, the potentiation processing is performed on basically one synapse unit 20. Accordingly, the larger the number of the synapse units 20, the larger the ratio of the first change amount (w₁) to the second change amount (w₂) is to be set. This makes it possible for the neural network device 10 to set the total value of the synaptic weights of the synapse units 20 to a value close to a constant value regardless of the progress of learning.

Moreover, the synaptic weight may be represented by a binary digit of a first value or a second value. For example, the first value is 1, and the second value is 0 or −1. In a case where the synaptic weight is represented by a binary digit, the neural network device 10 stochastically executes potentiation processing and attenuation processing.

Specifically, in the potentiation processing, the first synapse unit 20-1 does not change the value of the synaptic weight in a case where the synaptic weight is the first value (for example, 1), and changes the synaptic weight to the first value (for example, 1) with a predetermined first probability in a case where the synaptic weight is the second value (for example, 0 or −1).

Moreover, in the attenuation processing, the first synapse unit 20-1 does not change the value of the synaptic weight in a case where the synaptic weight is the second value (for example, 0 or −1), and changes the synaptic weight to the second value (for example, 0 or −1) with a predetermined second probability in a case where the synaptic weight is the first value (for example, 1).

Note that, in a case where the synaptic weight is represented by a binary digit, the first probability may be a value larger than the second probability. For example, the ratio setting may be performed such that the larger the number of the synapse units 20 that output the synapse signal to the post-neuron unit 34, the larger the ratio of the first probability to the second probability. The larger the number of the synapse units 20, the larger the ratio of the first probability to the second probability to be set. This makes it possible for the neural network device 10 to set the total value of the synaptic weights of the synapse units 20 to a value close to a constant value regardless of the progress of learning.

By updating the synaptic weight as described above, the neural network device 10 does not need to measure the time difference from the input of the input spike to the output of the output spike for each of the synapse units 20. With this configuration, with the neural network device 10 according to the embodiment, it is possible to achieve a small configuration. Moreover, in response to outputting the output spike from the post-neuron unit 34, the neural network device 10 executes the attenuation processing on the synaptic weight of each of the N synapse units 20 that output the synapse signal to the post-neuron unit 34. This makes it possible to proceed with the learning even without the input of the input spike to each of the N synapse units 20. Therefore, the neural network device 10 can proceed with learning of the synaptic weight corresponding to the blank part with no data. This makes it possible for the neural network device 10 according to the embodiment to perform learning with high accuracy.

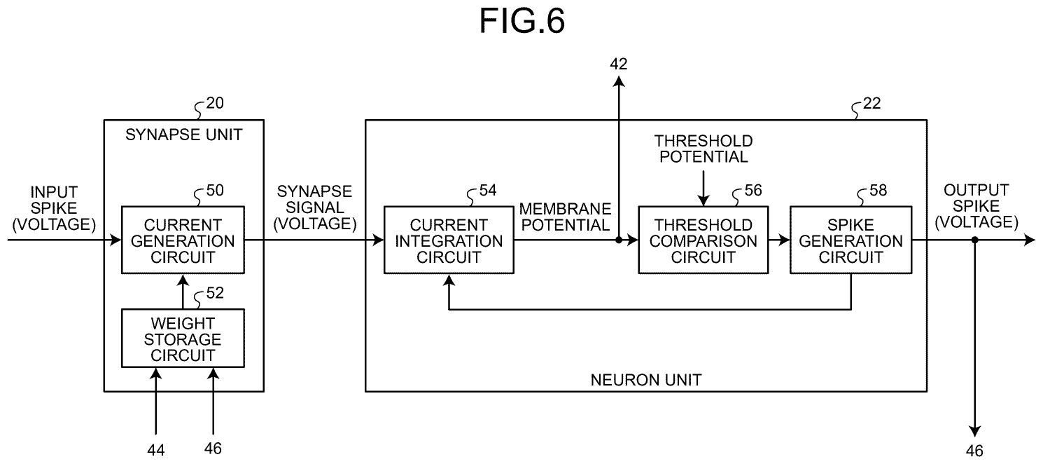

FIG. 6 is a diagram illustrating an example of a circuit configuration of the synapse unit 20 and the neuron unit 22 according to the embodiment. In a case where the synapse unit 20 and the neuron unit 22 are implemented by an electric circuit, for example, these units are configured as illustrated in FIG. 6, for example.

The synapse unit 20 includes a current generation circuit 50 and a weight storage circuit 52.

The current generation circuit 50 acquires an input spike from the pre-neuron unit 32. The input spike is a voltage pulse signal. In response to the input spike, the current generation circuit 50 outputs a current (synaptic current) corresponding to the synaptic weight stored in the weight storage circuit 52 as a synapse signal. The larger the synaptic weight, the larger the current of the synapse signal to be output from the current generation circuit 50.

The weight storage circuit 52 stores synaptic weights.

The neuron unit 22 includes a current integration circuit 54, a threshold comparison circuit 56, and a spike generation circuit 58.

The current integration circuit 54 accumulates the synapse signal (synaptic current) output from each of the one or more synapse units 20 in a capacitor, for example, and converts the signal into a voltage. The current integration circuit 54 outputs the converted voltage as a membrane potential. In addition, the current integration circuit 54 may change the membrane potential with time by a predetermined neuron model. For example, the current integration circuit 54 may decrease the membrane potential by a predetermined time constant according to a Leaky Integrate and Fire (LIF) model.

The threshold comparison circuit 56 has a predetermined threshold potential to be set, and compares the membrane potential with the threshold potential. The threshold comparison circuit 56 outputs a comparison result between the membrane potential and the threshold potential.

The spike generation circuit 58 acquires a comparison result from the threshold comparison circuit 56, and outputs an output spike when the membrane potential is larger than the threshold potential. The output spike is a voltage pulse signal. Additionally, in response to outputting the output spike, the spike generation circuit 58 decreases the membrane potential accumulated in the current integration circuit 54 to a preset initial value.

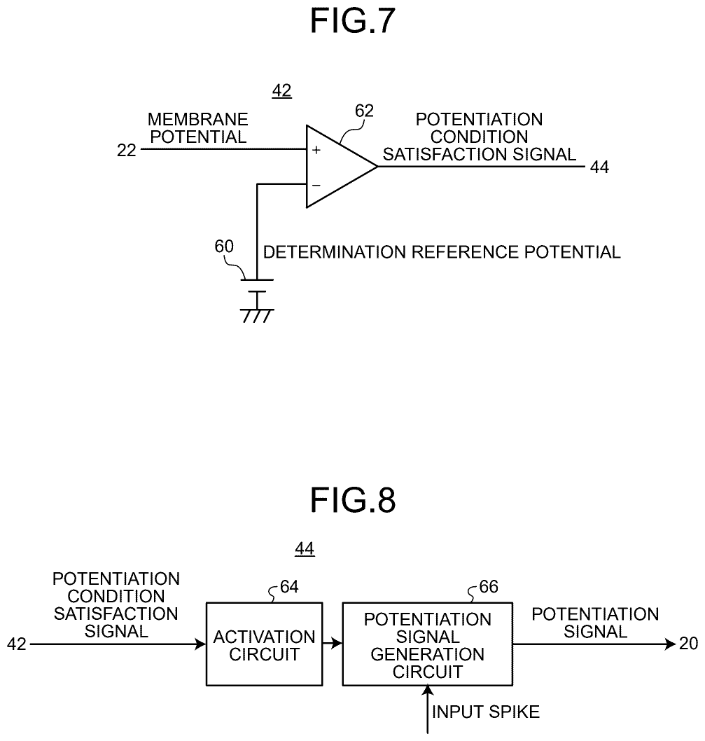

FIG. 7 is a diagram illustrating a circuit configuration of the potentiation determination unit 42 according to the embodiment. The potentiation determination unit 42, when being implemented by an electric circuit, is configured as illustrated in FIG. 7, for example.

The potentiation determination unit 42 includes a constant voltage generation circuit 60 and a voltage comparison circuit 62.

The constant voltage generation circuit 60 generates a determination reference potential. The voltage comparison circuit 62 is a comparator that compares the membrane potential output from the current integration circuit 54 of the neuron unit 22 with the determination reference potential generated from the constant voltage generation circuit 60. The voltage comparison circuit 62 outputs a potentiation condition satisfaction signal that has a predetermined voltage when the membrane potential is higher than the determination reference potential and has 0 voltage, for example, when the membrane potential is the determination reference potential or less. The voltage comparison circuit 62 supplies the potentiation condition satisfaction signal to the potentiation unit 44 corresponding to each of the synapse units 20 having the neuron unit 22 that has generated the membrane potential as the post-neuron unit 34.

FIG. 8 is a diagram illustrating a circuit configuration of the potentiation unit 44. The potentiation unit 44, when being implemented by an electric circuit, is configured as illustrated in FIG. 8, for example.

The potentiation unit 44 includes an activation circuit 64 and a potentiation signal generation circuit 66.

The activation circuit 64 acquires a potentiation condition satisfaction signal from the corresponding potentiation determination unit 42. The activation circuit 64 enables the subsequent potentiation signal generation circuit 66 only during a period in which the potentiation condition satisfaction signal has a predetermined voltage.

The potentiation signal generation circuit 66 acquires an input spike, being a spike input to the corresponding synapse unit 20. When having acquired an input spike while being enabled by the activation circuit 64, the potentiation signal generation circuit 66 outputs a potentiation signal to the corresponding synapse unit 20.

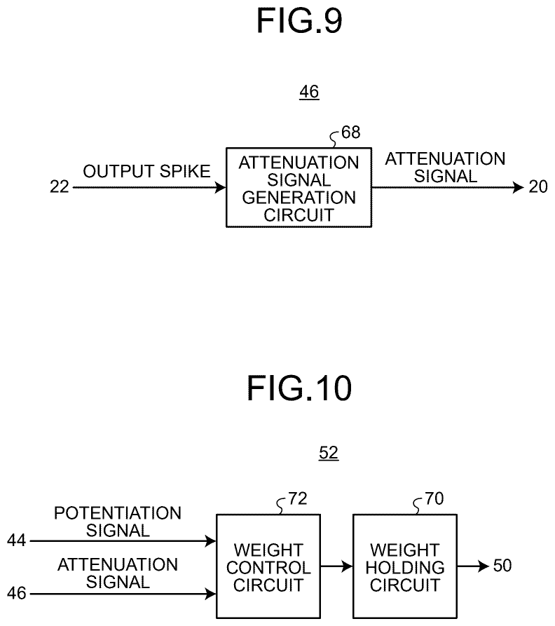

FIG. 9 is a diagram illustrating a circuit configuration of the attenuation unit 46. The attenuation unit 46, when being implemented by an electric circuit, is configured as illustrated in FIG. 9, for example.

The attenuation unit 46 includes an attenuation signal generation circuit 68. When an output spike is generated from the neuron unit 22, the attenuation signal generation circuit 68 outputs an attenuation signal to all the synapse units 20 having the neuron unit 22 that has generated the output spike as the post-neuron unit 34.

FIG. 10 is a diagram illustrating a configuration of a weight storage circuit 52.

The weight storage circuit 52 included in the synapse unit 20 includes a weight holding circuit 70 and a weight control circuit 72.

The weight holding circuit 70 includes a memory element that stores synaptic weights. The memory element may be a volatile memory element such as an SRAM cell or a DRAM cell (capacitor). Moreover, the memory element may be a MOS transistor including a floating gate or charge accumulation film. Moreover, the memory element may be a nonvolatile memory element such as a Magnetic Tunnel Junction element (MTJ or MRAM cell) and a resistance switching memory element (memristor). Moreover, the weight holding circuit 70 may store the synaptic weight as digital data or may store the synaptic weight as an analog amount.

The weight control circuit 72 acquires the potentiation signal from the potentiation unit 44. In addition, the weight control circuit 72 acquires the attenuation signal from the attenuation unit 46. When having acquired the potentiation signal, the weight control circuit 72 increases the synaptic weight stored in the memory element of the weight holding circuit 70 by the first change amount. In a case where the synaptic weight is the upper limit value, the weight control circuit 72 does not increase the synaptic weight even after acquiring the potentiation signal. When having acquired the attenuation signal, the weight control circuit 72 decreases the synaptic weight stored in the memory element of the weight holding circuit 70 by the second change amount. In a case where the synaptic weight is the lower limit value, the weight control circuit 72 does not decrease the synaptic weight even after acquiring the attenuation signal.

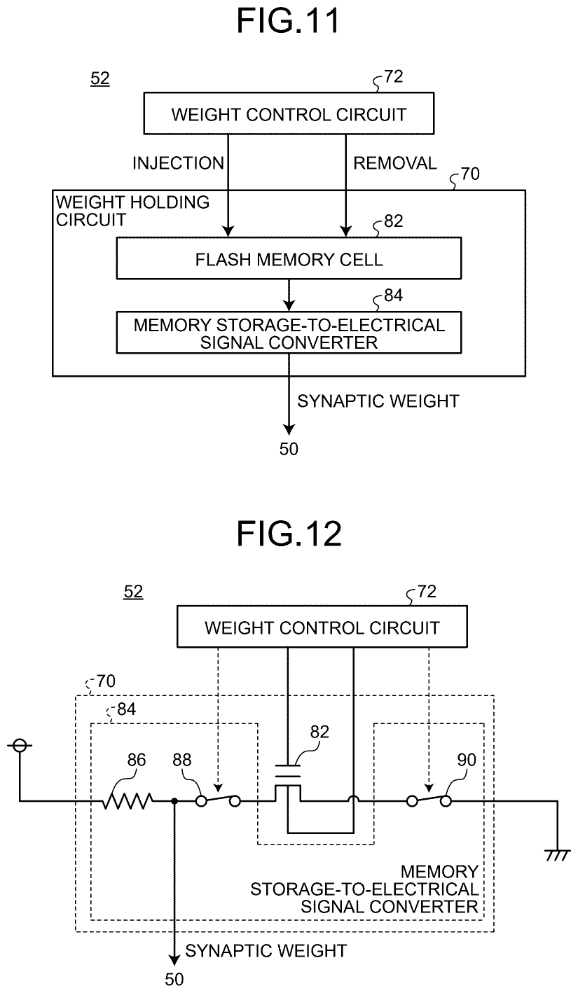

FIG. 11 is a diagram illustrating a configuration example of the weight storage circuit 52 using a flash memory cell 82.

For example, as illustrated in FIG. 11, the weight holding circuit 70 may include the flash memory cell 82 and a memory storage-to-electrical signal converter 84.

The flash memory cell 82 is an example of a memory element that stores a synaptic weight, and is formed with a MOS transistor having a floating gate or a charge accumulation film as a charge accumulation unit for accumulating a charge between a gate electrode and a gate insulating film. In the flash memory cell 82, the threshold of the transistor changes depending on the charge amount accumulated in the charge accumulation unit. Therefore, in the flash memory cell 82, even when the same gate voltage and source-drain voltage are applied, the current to flow changes depending on the accumulated charge amount. The charge accumulated in the charge accumulation layer does not change unless writing or erasing operation is performed. The flash memory cell 82 stores synaptic weights by using such properties.

When having acquired one of the potentiation signal and the attenuation signal, the weight control circuit 72 injects a predetermined amount of charge into the flash memory cell 82. When having acquired the other of the potentiation signal and the attenuation signal, the weight control circuit 72 removes a predetermined amount of charge from the flash memory cell 82.

The memory storage-to-electrical signal converter 84 converts the amount of charge stored in the flash memory cell 82 into an electrical signal and feeds the electrical signal to the current generation circuit 50 as a signal representing a synaptic weight.

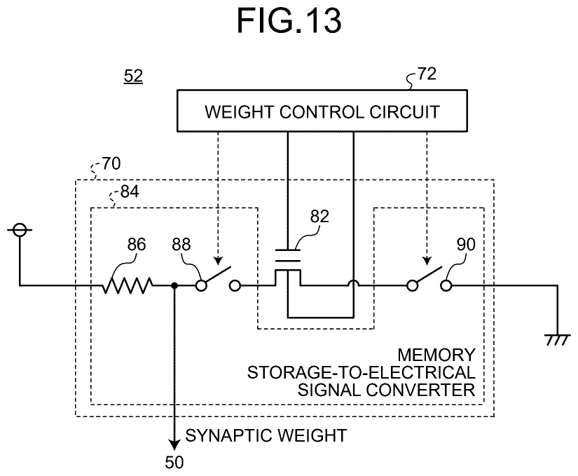

FIGS. 12 and 13 are diagrams illustrating a circuit example of the weight storage circuit 52 using the flash memory cell 82. FIG. 12 is a circuit diagram illustrating a state at the time of reading the synaptic weight. FIG. 13 is a circuit diagram illustrating a state at the time of updating the synaptic weight.

The flash memory cell 82 and the memory storage-to-electrical signal converter 84 are implemented by circuits as illustrated in FIGS. 12 and 13, for example.

The memory storage-to-electrical signal converter 84 includes a resistor 86, a first switch 88, and a second switch 90.

The flash memory cell 82 has its gate electrode received an applied voltage from the weight control circuit 72. In addition, the flash memory cell 82 has its substrate electrode receive an applied voltage from the weight control circuit 72.

The resistor 86 has its one node connected to a power supply potential terminal having a predetermined voltage. The first switch 88 short-circuits or opens between one of the source electrode and the drain electrode in the flash memory cell 82 and a node on a side not connected to the power supply potential terminal of the resistor 86. The second switch 90 short-circuits or opens between the electrode on the side to which the first switch 88 is not connected among the source electrode and the drain electrode in the flash memory cell 82 and the ground potential. The first switch 88 and the second switch 90 are controlled by the weight control circuit 72.

When reading a synaptic weight from the flash memory cell 82, the weight control circuit 72 short-circuits between the first switch 88 and the second switch 90 as illustrated in FIG. 12. In addition, the weight control circuit 72 applies a read potential to the gate electrode. This operation allows a current corresponding to the charge amount accumulated in the charge accumulation unit to flow between the source and the drain of the flash memory cell 82. When the flash memory cell 82 is an N-type, the larger the amount of accumulated charges, the smaller the current will be. Accordingly, the smaller the charge amount, the lower the potential of the node between the resistor 86 and the first switch 88 will be; the larger the charge amount, the higher the potential will be. The weight control circuit 72 supplies a signal corresponding to the potential of the node between the resistor 86 and the first switch 88 to the current generation circuit 50 as a signal representing a synaptic weight.

When updating the charge amount accumulated in the flash memory cell 82, the weight control circuit 72 opens the first switch 88 and the second switch 90 as illustrated in FIG. 13. With this configuration, the weight control circuit 72 can prevent a voltage applied to the flash memory cell 82 from being applied to the surrounding circuits at the time of updating the charge amount, and a current flowing through the flash memory cell 82 from flowing to the surrounding circuits at the time of updating the charge amount.

When increasing the amount of charges accumulated in the flash memory cell 82, the weight control circuit 72 sets the substrate electrode of the flash memory cell 82 to 0 V, for example, and applies a high voltage to the gate electrode of the flash memory cell 82 to inject charges into the charge accumulation layer. When decreasing the amount of charges accumulated in the flash memory cell 82, the weight control circuit 72 sets the gate electrode of the flash memory cell 82 to 0 V, for example, and applies a high voltage to the substrate electrode of the flash memory cell 82 to remove charges from the charge accumulation layer.

Note that the weight control circuit 72 may adjust the injection amount and the removal amount of charges by controlling the voltage amount and the application time of the high voltage. This makes it possible for the weight control circuit 72 to achieve a synaptic weight representing a continuous value or a synaptic weight representing a multistage discrete value.

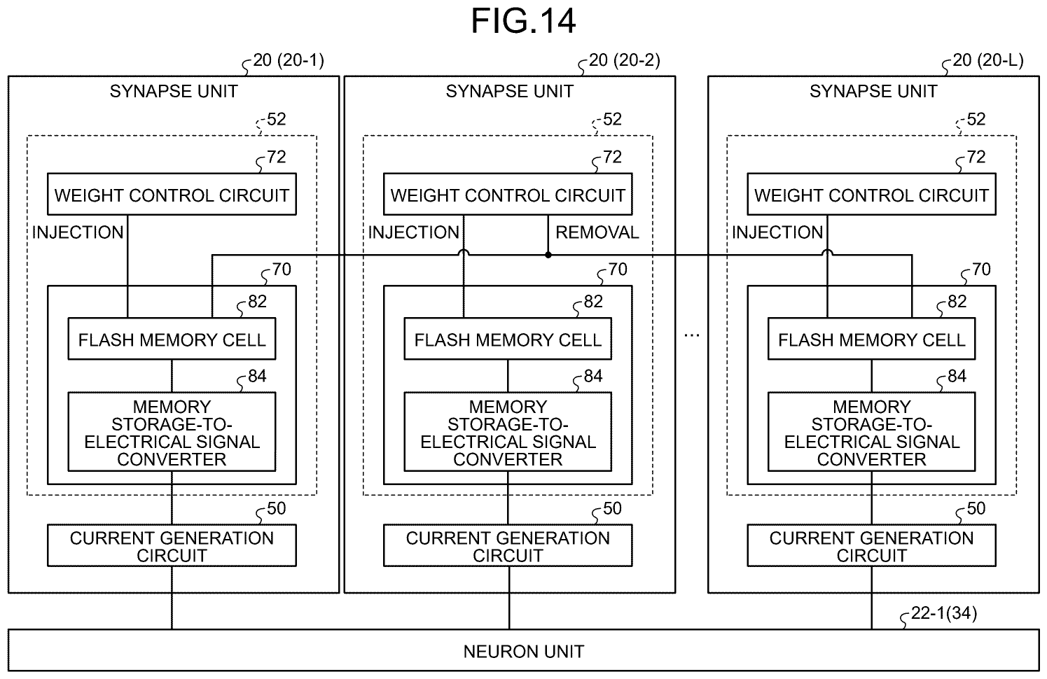

FIG. 14 is a diagram illustrating a configuration of each of two or more synapse units 20 having the target neuron unit 22-1 being set as the post-neuron unit 34.

For example, the neural network device 10 is supposed to include L synapse units 20 (20-1, 20-2, . . . , 20-L) having any optionally selected target neuron unit 22-1 among the neuron units 22 being set as the post-neuron unit 34. L is an integer of 2 or more.

In addition, each of the synapse units 20 included in the neural network device 10 includes a weight storage circuit 52 using the flash memory cell 82. In this case, the flash memory cells 82 included in each of the L synapse units 20 may be provided on an identical well in the semiconductor.

In a case where a spike signal is output from any of the neuron units 22, the neural network device 10 executes an attenuation processing on the synaptic weights stored in all the synapse units 20 having the neuron unit 22 as the post-neuron unit 34. Therefore, by arranging the flash memory cells 82 included in the weight storage circuits 52 of the L synapse units 20 having the identical neuron unit 22 as the post-neuron unit 34 on the identical well, the neural network device 10 can collectively perform the charge removal operation. In this case, as illustrated in FIG. 14, the weight control circuit 72 included in any one synapse unit 20 among the L synapse units 20 applies a high voltage and a control signal to the flash memory cell 82 included in each of the L synapse units 20. In the neural network device 10, by arranging the flash memory cells 82 included in the weight storage circuits 52 of the L synapse units 20 on an identical well, it is possible to perform high density integration of the flash memory cells 82, leading to reduction of chip area.

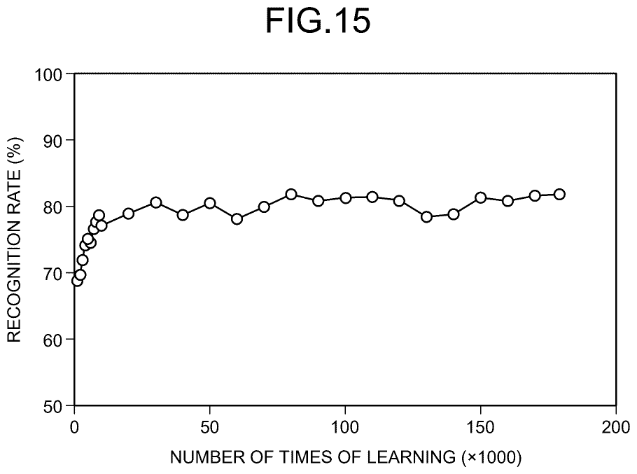

FIG. 15 is a graph illustrating a recognition rate obtained by simulation regarding a test pattern as evaluation of the neural network device 10 which has been trained to learn the MNIST handwritten character pattern.

As illustrated in FIG. 15, by performing learning with a certain number of times of training, the neural network device 10 can recognize the MNIST handwritten characters at a recognition rate of about 80%. In this manner, the neural network device 10 can perform learning with practically sufficient accuracy.

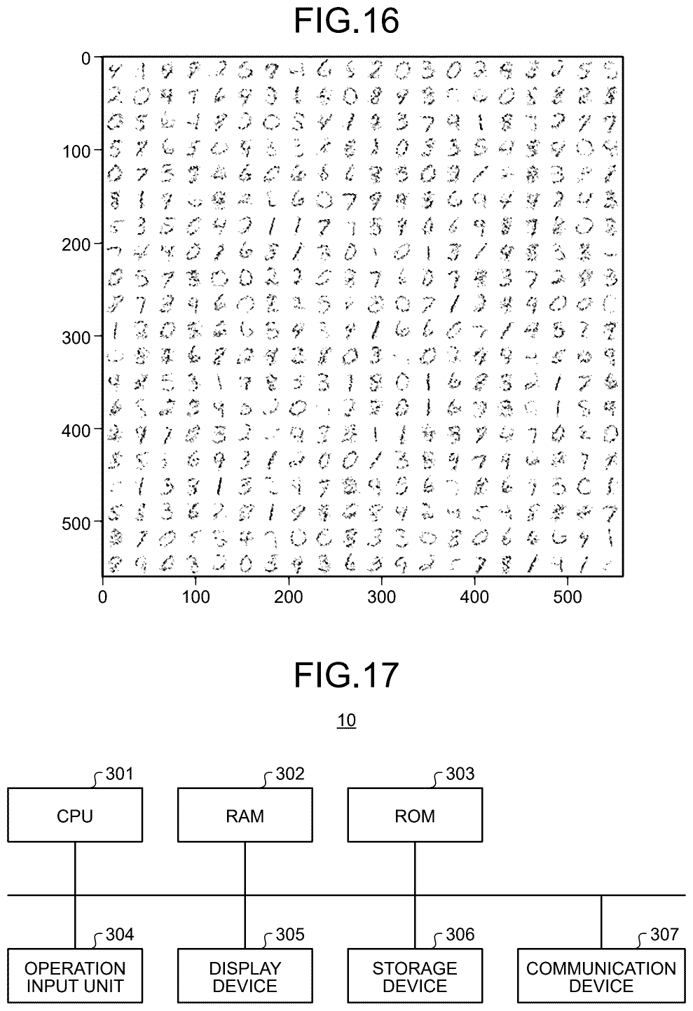

FIG. 16 is a diagram illustrating a receptive field after the neural network device 10 is trained to learn the MNIST handwritten character pattern simulation.

As illustrated in the receptive field of FIG. 16, the neural network device 10 according to the embodiment has subjected to training regarding each of the character part and the blank part. Therefore, the neural network device 10 according to the embodiment can perform learning with practically sufficient accuracy with no residuals of previously learned information.

As described above, the neural network device 10 according to the present embodiment, the configuration can achieve a small configuration. In addition, the neural network device 10 according to the present embodiment makes it possible to proceed with the learning of the synaptic weight corresponding to the blank part including no data so as to achieve learning with high accuracy.

### Hardware Configuration of Information Processing Apparatus

FIG. 17 is a diagram illustrating an example of a hardware configuration of the neural network device 10 when being implemented using a computer.

The neural network device 10 may be implemented by a computer (information processing apparatus) having a hardware configuration as illustrated in FIG. 17, for example, instead of the analog circuit. In this case, the neural network device 10 includes a central processing unit (CPU) 301, random access memory (RAM) 302, read only memory (ROM) 303, an operation input device (or operation input unit) 304, a display device 305, a storage device 306, and a communication device 307. These components are interconnected by a bus.

The CPU 301 is a processor that executes arithmetic processing, control processing, and the like in accordance with a computer program. The CPU 301 executes various processes in cooperation with a computer program stored in the ROM 303, the storage device 306, or the like, by using a predetermined area of the RAM 302 as a work area.

The RAM 302 is memory such as synchronous dynamic random access memory (SDRAM). The RAM 302 functions as a work area of the CPU 301. The ROM 303 is memory that stores computer programs and various types of information in a non-rewritable manner.

The operation input device 304 is an input device such as a mouse and a keyboard. The operation input device 304 receives information operationally input from the user as an instruction signal, and outputs the instruction signal to the CPU 301.

The display device 305 is a display device such as a liquid crystal display (LCD). The display device 305 displays various types of information based on a display signal from the CPU 301.

The storage device 306 is a device that writes and reads data in and from a semiconductor storage medium such as flash memory, a magnetically or optically recordable storage medium, or the like. The storage device 306 writes and reads data in and from the storage medium under the control of the CPU 301. The communication device 307 communicates with an external device via a network under the control of the CPU 301.

The program executed by the computer includes a synapse module, a neuron module, a potentiation determination module, a potentiation module, and an attenuation module.

This program is developed and executed on the RAM 302 by the CPU 301 (processor), thereby causing the computer to function as the synapse unit 20, the neuron unit 22, the potentiation determination unit 42, the potentiation unit 44, and the attenuation unit 46. Note that a part or all of the synapse unit 20, the neuron unit 22, the potentiation determination unit 42, the potentiation unit 44, and the attenuation unit 46 may be implemented by a hardware circuit. A part or all of the synapse unit 20, the neuron unit 22, the potentiation determination unit 42, the potentiation unit 44, and the attenuation unit 46 may be implemented by the GP-GPU.

The program executed by the computer is recorded and provided in a computer-readable recording medium such as a CD-ROM, a flexible disk, a CD-R, a digital versatile disk (DVD) in a file in a computer-installable format or an executable format.

Moreover, this program may be stored on a computer connected to a network such as the Internet and provided by being downloaded via the network. Moreover, this program may be provided or distributed via a network such as the Internet. Moreover, the program executed by the neural network device 10 may be provided by being incorporated in the ROM 303 or the like, in advance.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplement

The above embodiment can be summarized in the following technical schemes.

### (Technical Scheme 1)

A neural network device comprising:
a plurality of neuron circuits; and
a plurality of synapse circuits, wherein
each of the neuron circuits is configured to
   receive a synapse signal output from each of one or more of the synapse circuits,
   increase an internal state value representing an internal state in response to receiving the synapse signal,
   output a spike signal in accordance with the internal state value, and
   decrease the internal state value in response to outputting the spike signal,
each of the synapse circuits is configured to
   store a synaptic weight,
   acquire an input spike being the spike signal output from a first neuron circuit being one of the neuron circuits, and
   output, to a second neuron circuit being one of the neuron circuits, the synapse signal obtained by adding influence of the synaptic weight to the acquired input spike, and
a first synapse circuit being one of the synapse circuits is configured to,
   when the internal state value of the second neuron circuit is larger than a determination reference value, execute potentiation processing to increase a degree of influence of the synaptic weight on the synapse signal in response to acquiring the input spike from the first neuron circuit, and
   execute attenuation processing to decrease the degree of influence of the synaptic weight on the synapse signal in response to outputting an output spike being the spike signal from the second neuron circuit.

### (Technical Scheme 2)

The neural network device according to the technical scheme 1, wherein the first synapse circuit is configured to
increase the synaptic weight by a predetermined first change amount in the potentiation processing, and
decrease the synaptic weight by a predetermined second change amount in the attenuation processing.

### (Technical Scheme 3)

The neural network device according to the technical scheme 1, wherein the first synapse circuit is configured to
increase the synaptic weight by a predetermined first change amount at a predetermined first probability in the potentiation processing, and
decrease the synaptic weight by a predetermined second change amount at a predetermined second probability in the attenuation processing.

### (Technical Scheme 4)

The neural network device according to any one of the technical schemes 1 to 3, wherein
the spike signal is a pulse signal, and
each of the synapse circuits is configured to output, to the second neuron circuit, the synapse signal representing a value corresponding to the synaptic weight in response to acquiring the input spike.

### (Technical Scheme 5)

The neural network device according to the technical scheme 4, wherein each of the synapse circuits is configured to output, to the second neuron circuit, the synapse signal representing a current corresponding to the synaptic weight in response to acquiring the input spike.

### (Technical Scheme 6)

The neural network device according to the technical scheme 5, wherein each of the neuron circuits is configured to hold a membrane potential as the internal state value.

### (Technical Scheme 7)

The neural network device according to the technical scheme 6, further comprising a potentiation determination circuit configured to determine whether the membrane potential is higher than a determination reference potential being a potential corresponding to the determination reference value.

### (Technical Scheme 8)

The neural network device according to the technical scheme 7, wherein the potentiation determination circuit is configured to change the determination reference value in accordance with an occurrence frequency of the output spike per unit time.

### (Technical Scheme 9)

The neural network device according to any one of the technical schemes 1 to 8, wherein the synaptic weight is represented by a discrete value.

### (Technical Scheme 10)

The neural network device according to the technical scheme 9, wherein the synaptic weight is represented by a binary digit of a first value or a binary digit of a second value.

### (Technical Scheme 11)

The neural network device according to the technical scheme 10, wherein the first synapse circuit is configured to,
in the potentiation processing,
   keep the value of the synaptic weight in a case where the synaptic weight is the first value, and
   change the synaptic weight to the first value at a predetermined first probability in a case where the synaptic weight is the second value, and,
in the attenuation processing,
   keep the value of the synaptic weight in a case where the synaptic weight is the second value, and
   change the synaptic weight to the second value at a predetermined second probability in a case where the synaptic weight is the first value, the first synapse circuit.

### (Technical Scheme 12)

The neural network device according to any one of the technical schemes 1 to 11, wherein the first synapse circuit includes a flash memory cell to store the synaptic weight.

### (Technical Scheme 13)

The neural network device according to any one of the technical schemes 1 to 11, wherein
the synapse circuits include L synapse circuits (L is an integer of 2 or more), each being correlated with a target neuron circuit among the neuron circuits as the second neuron circuit,
each of the L synapse circuits includes a flash memory cell to store the synaptic weight, and
the flash memory cell included in each of the L synapse circuits is provided on an identical well of a semiconductor.

### (Technical Scheme 14)

A synaptic weight update method implemented by a computer of a neural network device including a plurality of neuron circuits and a plurality of synapse circuits, the method comprising:
in each of the neuron circuits,
   receiving a synapse signal output from each of one or more of the synapse circuits,
   increasing an internal state value representing an internal state in response to receiving the synapse signal,
   outputting a spike signal in accordance with the internal state value, and
   decreasing the internal state value in response to outputting the spike signal,
in each of the synapse circuits,
   storing a synaptic weight,
   acquiring an input spike being the spike signal output from a first neuron circuit being one of the neuron circuits, and
   outputting, to a second neuron circuit being one of the neuron circuits, the synapse signal obtained by adding influence of the synaptic weight to the acquired input spike, and,
in a first synapse circuit being one of the synapse circuits,
   when the internal state value of the second neuron circuit is larger than a determination reference value, executing potentiation processing to increase a degree of influence of the synaptic weight on the synapse signal in response to acquiring the input spike from the first neuron circuit, and
   executing attenuation processing to decrease the degree of influence of the synaptic weight on the synapse signal in response to outputting an output spike being the spike signal from the second neuron circuit.

### (Technical Scheme 15)

A computer program product comprising a non-transitory computer-readable recording medium on which a computer program executable by a computer of a neural network device is recorded, the neural network device including a plurality of neuron circuits and a plurality of synapse circuits, the computer program instructing the computer to perform processing, the processing including:
in each of the neuron circuits,
   receiving a synapse signal output from each of one or more of the synapse circuits,
   increasing an internal state value representing an internal state in response to receiving the synapse signal,
   outputting a spike signal in accordance with the internal state value, and
   decreasing the internal state value in response to outputting the spike signal,
in each of the synapse circuits,
   storing a synaptic weight,
   acquiring an input spike being the spike signal output from a first neuron circuit being one of the neuron circuits, and
   outputting, to a second neuron circuit being one of the neuron circuits, the synapse signal obtained by adding influence of the synaptic weight to the acquired input spike, and,
in a first synapse circuit being one of the synapse circuits,
   when the internal state value of the second neuron circuit is larger than a determination reference value, executing potentiation processing to increase a degree of influence of the synaptic weight on the synapse signal in response to acquiring the input spike from the first neuron circuit, and
   executing attenuation processing to decrease the degree of influence of the synaptic weight on the synapse signal in response to outputting an output spike being the spike signal from the second neuron circuit.

What is claimed is:

1. A neural network device comprising:
a plurality of neuron circuits; and
a plurality of synapse circuits, wherein
each of the neuron circuits is configured to
receive a synapse signal output from each of one or more of the synapse circuits,
increase an internal state value representing an internal state in response to receiving the synapse signal,
output a spike signal in accordance with the internal state value, and
decrease the internal state value in response to outputting the spike signal,
each of the synapse circuits is configured to
store a synaptic weight,
acquire an input spike being the spike signal output from a first neuron circuit being one of the neuron circuits, and
output, to a second neuron circuit being one of the neuron circuits, the synapse signal obtained by adding influence of the synaptic weight to the acquired input spike, and
a first synapse circuit being one of the synapse circuits is configured to,
when the internal state value of the second neuron circuit is larger than a determination reference value, execute potentiation processing to increase a degree of influence of the synaptic weight on the synapse signal in response to acquiring the input spike from the first neuron circuit, and
execute attenuation processing to decrease the degree of influence of the synaptic weight on the synapse signal in response to outputting an output spike being the spike signal from the second neuron circuit.

2. The neural network device according to claim 1, wherein the first synapse circuit is configured to
increase the synaptic weight by a predetermined first change amount in the potentiation processing, and
decrease the synaptic weight by a predetermined second change amount in the attenuation processing.

3. The neural network device according to claim 1, wherein the first synapse circuit is configured to
increase the synaptic weight by a predetermined first change amount at a predetermined first probability in the potentiation processing, and
decrease the synaptic weight by a predetermined second change amount at a predetermined second probability in the attenuation processing.

4. The neural network device according to claim 1, wherein
the spike signal is a pulse signal, and
each of the synapse circuits is configured to output, to the second neuron circuit, the synapse signal representing a value corresponding to the synaptic weight in response to acquiring the input spike.

5. The neural network device according to claim 4, wherein each of the synapse circuits is configured to output, to the second neuron circuit, the synapse signal representing a current corresponding to the synaptic weight in response to acquiring the input spike.

6. The neural network device according to claim 5, wherein each of the neuron circuits is configured to hold a membrane potential as the internal state value.

7. The neural network device according to claim 6, further comprising a potentiation determination circuit configured to determine whether the membrane potential is higher than a determination reference potential being a potential corresponding to the determination reference value.

8. The neural network device according to claim 7, wherein the potentiation determination circuit is configured to change the determination reference value in accordance with an occurrence frequency of the output spike per unit time.

9. The neural network device according to claim 1, wherein the synaptic weight is represented by a discrete value.

10. The neural network device according to claim 9, wherein the synaptic weight is represented by a binary digit of a first value or a binary digit of a second value.

11. The neural network device according to claim 10, wherein the first synapse circuit is configured to,
in the potentiation processing,
keep the value of the synaptic weight in a case where the synaptic weight is the first value, and
change the synaptic weight to the first value at a predetermined first probability in a case where the synaptic weight is the second value, and,
in the attenuation processing,
keep the value of the synaptic weight in a case where the synaptic weight is the second value, and
change the synaptic weight to the second value at a predetermined second probability in a case where the synaptic weight is the first value, the first synapse circuit.

12. The neural network device according to claim 1, wherein the first synapse circuit includes a flash memory cell to store the synaptic weight.

13. The neural network device according to claim 1, wherein
the synapse circuits include L synapse circuits (L is an integer of 2 or more), each being correlated with a target neuron circuit among the neuron circuits as the second neuron circuit,
each of the L synapse circuits includes a flash memory cell to store the synaptic weight, and
the flash memory cell included in each of the L synapse circuits is provided on an identical well of a semiconductor.

14. A synaptic weight update method implemented by a computer of a neural network device including a plurality of neuron circuits and a plurality of synapse circuits, the method comprising:
in each of the neuron circuits,
receiving a synapse signal output from each of one or more of the synapse circuits,
increasing an internal state value representing an internal state in response to receiving the synapse signal,
outputting a spike signal in accordance with the internal state value, and
decreasing the internal state value in response to outputting the spike signal,
in each of the synapse circuits,
storing a synaptic weight,
acquiring an input spike being the spike signal output from a first neuron circuit being one of the neuron circuits, and
outputting, to a second neuron circuit being one of the neuron circuits, the synapse signal obtained by adding influence of the synaptic weight to the acquired input spike, and,
in a first synapse circuit being one of the synapse circuits,
when the internal state value of the second neuron circuit is larger than a determination reference value, executing potentiation processing to increase a degree of influence of the synaptic weight on the synapse signal in response to acquiring the input spike from the first neuron circuit, and
executing attenuation processing to decrease the degree of influence of the synaptic weight on the synapse signal in response to outputting an output spike being the spike signal from the second neuron circuit.

15. A computer program product comprising a non-transitory computer-readable recording medium on which a computer program executable by a computer of a neural network device is recorded, the neural network device including a plurality of neuron circuits and a plurality of synapse circuits, the computer program instructing the computer to perform processing, the processing including:
in each of the neuron circuits,
receiving a synapse signal output from each of one or more of the synapse circuits,
increasing an internal state value representing an internal state in response to receiving the synapse signal,
outputting a spike signal in accordance with the internal state value, and
decreasing the internal state value in response to outputting the spike signal,
in each of the synapse circuits,
storing a synaptic weight,
acquiring an input spike being the spike signal output from a first neuron circuit being one of the neuron circuits, and
outputting, to a second neuron circuit being one of the neuron circuits, the synapse signal obtained by adding influence of the synaptic weight to the acquired input spike, and,
in a first synapse circuit being one of the synapse circuits,
when the internal state value of the second neuron circuit is larger than a determination reference value, executing potentiation processing to increase a degree of influence of the synaptic weight on the synapse signal in response to acquiring the input spike from the first neuron circuit, and
executing attenuation processing to decrease the degree of influence of the synaptic weight on the synapse signal in response to outputting an output spike being the spike signal from the second neuron circuit.
